(19) United States
(12) Patent Application Publication
(10) Pub. No.: US 2025/0116867 A1
(43) Pub. Date: Apr. 10, 2025

(54) DIOPTER ADJUSTMENT FOR A HEAD-MOUNTED DISPLAY USING ELECTRICALLY-CONTROLLABLE LENSES

(71) Applicant: Valve Corporation, Bellevue, WA (US)

(72) Inventor: Joshua Mark Hudman, Issaquah, WA (US)

(21) Appl. No.: 18/911,832

(22) Filed: Oct. 10, 2024

Related U.S. Application Data
(60) Provisional application No. 63/589,099, filed on Oct. 10, 2023.

(51) Int. Cl. G02B 27/01; G02B 27/09; G02F 1/29

(52) U.S. Cl. CPC G02B 27/0172; G02B 27/0955; G02F 1/294; G02B 2027/014

(57) ABSTRACT

Using electrically-controllable lenses to provide a head-mounted display (HMD) with a diopter adjustment capability is disclosed. The electrically-controllable lenses may be coupled, or couplable, to a pair of lens tubes of the HMD and configured to direct light emitted by a display panel(s) of the HMD toward eyes of a user wearing the HMD. A processor(s) may be configured to execute computer-executable instructions stored in memory to provide a control signal(s) to the electrically-controllable lens(es) to adjust an optical power of the electrically-controllable lens(es).

### CROSS-REFERENCE TO RELATED APPLICATION

This application claims to priority to and benefit of U.S. Provisional Application No. 63/589,099, filed Oct. 10, 2023, entitled “DIOPTER ADJUSTMENT FOR A HEAD-MOUNTED DISPLAY USING ELECTRICALLY-CONTROLLABLE LENSES,” the entirety of which is incorporated by reference herein for all purposes.

### BACKGROUND

Head-mounted displays (HMDs) are used in various fields including engineering, medical, military, and video gaming. HMDs present graphical information or images to a user as part of a virtual reality (VR), augmented reality (AR), and/or a mixed reality (MR) environment. As an example, while playing a VR video game, a user may wear a HMD to be immersed within a virtual environment. Some users of HMDs have impaired vision, such as nearsightedness, farsightedness, or astigmatism. However, it can be uncomfortable for such users to wear their prescription eyeglasses underneath a HMD.

Provided herein are technical solutions to improve and enhance these and other systems.

### BRIEF DESCRIPTION OF THE DRAWINGS

FIG. 1 illustrates a perspective view of an example pair of electrically-controllable lenses and an example HMD having a pair of lens tubes to which the electrically-controllable lenses may be coupled, in accordance with embodiments disclosed herein.

FIG. 2 illustrates a front view of an example pair of electrically-controllable lenses, the optical power of which is adjustable via the provisioning of control signals to the electrically-controllable lenses, in accordance with embodiments disclosed herein.

FIG. 3 illustrates side views of an electrically-controllable lens, and techniques for using the electrically-controllable lens to increase or decrease the optical power of the electrically-controllable lens, in accordance with embodiments disclosed herein.

FIG. 4 is a flow diagram of an example process for controlling an electrically-controllable lens(es) of a HMD based on user input provided by a user wearing the HMD in order to provide vision correction for the user, in accordance with embodiments disclosed herein.

FIG. 5 is a flow diagram of an example process for using an electrically-controllable lens(es) to mimic a light field display in a HMD, in accordance with embodiments disclosed herein.

FIG. 6 illustrates example components of a system in which the techniques disclosed herein can be implemented, in accordance with embodiments disclosed herein.

### DETAILED DESCRIPTION

Roughly 50% of HMD users have impaired vision, such as nearsightedness, farsightedness, astigmatism, or other eye conditions. These users can wear their HMDs without wearing their prescription eyewear (e.g., eyeglasses, contact lenses, etc.), but in doing so, they will not have a clear view of the images displayed via the HMD. The severity of the user's blurred vision depends on the severity of the user's vision impairment. Most HMDs do not have enough space to accommodate prescription eyeglasses, making it uncomfortable, if not impossible, for users with impaired vision to wear their prescription eyeglasses underneath the HMD. Another option for users with impaired vision is to wear prescription contact lenses underneath a HMD. However, many users do not possess, do not like wearing, or cannot wear contact lenses for various reasons. Moreover, sweating can cause issues with contact lenses. For example, if a contact-lens-wearing user is frequently moving around while wearing a HMD, such as during a physical VR experience, the user may begin to sweat, and their contact lenses may absorb the resulting moisture inside of the HMD, rendering their contact lenses uncomfortable to wear. Users with impaired vision can order custom prescription lens adapters for their HMD, but these lens adapters are customized only for the individual user, which renders the lens adapters useless for other users (e.g., friends or family) with different eye prescriptions.

Described herein are, among other things, techniques, devices, and systems for using electrically-controllable lenses to provide a HMD with a diopter adjustment capability. The HMD described herein can take many forms, including a helmet, a visor, goggles, a mask, glasses, or any other suitable type of head and/or eyewear worn on the head of a user. The HMD may include one or more display panels that display images (e.g., frames) for viewing by the user wearing the HMD. In some examples, the images are rendered by an application, which may be executing onboard the HMD and/or on a separate computing device (e.g., a personal computer, video game console, etc.) that is communicatively coupled (wired or wirelessly) to the HMD. Additionally, in some examples, the user may operate one or more handheld controllers in conjunction with the HMD to further engage in a VR, AR, and/or MR environment.

The HMD may further include an optical subsystem that directs light from the display panel(s) to a user's eyes using one or more optical elements. The optical subsystem can configure the HMD as a near-eye display by using one or more optical elements to focus light emitted by the display panel(s) onto the user's eyes, which are relatively close to the display panel(s). Various types and combinations of different optical elements may be used to bend the light from the display panel(s) to make the display panel(s) appear to the user to be farther away than it actually is. For example, the optical subsystem may include, without limitation, apertures, lenses (e.g., Fresnel lenses, convex lenses, concave lenses, etc.), filters, and so forth. The optical element(s) of the optical subsystem may be disposed within a pair of lens tubes of the HMD. The lens tubes are positioned in front of the display panel(s), and, when the user is wearing the HMD, the lens tubes are positioned between the user's eyes and the display panel(s). Although the optical subsystem of the HMD may be designed to correct one or more optical errors (e.g., barrel distortion, pincushion distortion, longitudinal chromatic aberration, transverse chromatic aberration, spherical aberration, comatic aberration, field curvature, etc.), the optical elements (e.g., lenses) within the lens tubes may nevertheless be designed for users who are not vision-impaired (i.e., users with “good” vision).

Accordingly, a system including the HMD may include one or more electrically-controllable lenses. The electrically-controllable lens(es) described herein is/are usable with the HMD for, among other things, diopter adjustment. That is, a processor(s) of the system can provide a control signal(s) to the electrically-controllable lens(es) to adjust an optical power of the electrically-controllable lens(es). For example, the optical power of the electrically-controllable lens(es) can be increased in order to decrease the focal length of the electrically-controllable lens(es), or the optical power of the electrically-controllable lens(es) can be decreased in order to increase the focal length of the electrically-controllable lens(es). In some examples, using the electrically-controllable lens(es) for diopter adjustment allows for mimicking a user's prescription eyewear. This, in turn, allows users with impaired vision to have a clear and sharp view of the images displayed on the display panel(s) of the HMD without having to wear their prescription eyewear (e.g., eyeglasses, contact lenses, etc.) underneath the HMD.

In some examples, a user wearing the HMD can provide user input to adjust the optical power of the electrically-controllable lens(es). The type of user input and the types of devices that receive the user input for diopter adjustment can vary depending on the implementation. For example, the HMD may include a dedicated control(s) (e.g., an actuator(s), such as a rotatable knob(s)) that is operable by a finger(s) of the user for adjusting the optical power of the electrically-controllable lens(es). As another example, the user may provide user input via a handheld controller(s) to adjust the optical power of the electrically-controllable lens(es), such as by using the handheld controller(s) to interact with a user interface element(s) presented on the display panel(s) of the HMD. In some examples, the user may utter a voice command to adjust the optical power of the electrically-controllable lens(es), and this voice command can be detected by a microphone(s) of the HMD for enabling diopter adjustment. Regardless of the type of user input or the type of device and/or control(s) that receives it, a processor(s) of the system may be configured to provide a control signal(s) to the electrically-controllable lens(es) to adjust the optical power of the electrically-controllable lens(es) based at least in part on the user input. The diopter adjustment is intuitive for a user wearing the HMD because the user can increase or decrease the optical power of the electrically-controllable lenses, as needed, until the displayed images look clear and sharp to the user.

In some examples, a pair of electrically-controllable lenses are usable with the HMD. In these examples, each electrically-controllable lens may be controllable independently of the other electrically-controllable lens. Having each electrically-controllable lens be independently controllable allows for providing vision correction for vision-impaired users who have different prescriptions for each eye. Moreover, the electrically-controllable lenses can be used to correct for astigmatism, and perhaps other eye conditions, in addition to nearsightedness and farsightedness, as described in more detail below. The electrically-controllable lens(es) described herein are also “universal” in the sense that they can be used by multiple different vision-impaired users (e.g., different users in the same household) with different eye prescriptions. Accordingly, the electrically-controllable lens(es) described herein are an improvement over conventional lens adapters that are only usable for users with a particular eye prescription because their optical power cannot be adjusted.

The use of electrically-controllable lenses for diopter adjustment in a HMD eliminates the need for moving parts (e.g., movable lenses) and mechanical adjustment mechanisms within the HMD. Conventional diopter adjustment mechanisms, such as Alvarez lenses, would require more space within the HMD to accommodate the movement of lenses within the HMD. By contrast, the electrically-controllable lenses described herein allow for conserving this valuable space within the HMD (e.g., occupying the space with other useful components), or otherwise reducing the size and weight of the HMD to provide a lightweight HMD with a relatively small form factor. The elimination of moving parts for diopter adjustment also means that the HMD is less prone to failure. The electrically-controllable lens(es) can also be made as a flat lens(es) of substantially uniform thickness. In view of the above, the electrically-controllable lens(es) described herein provide numerous technical benefits over conventional diopter adjustment mechanisms that rely on mechanical moving parts, such as Alvarez lenses. This constitutes an improvement to optics technology used in HMDs.

The techniques, devices, and systems described herein can provide other enhancements and benefits in lieu of, or in addition to, vision correction for vision-impaired users. For example, the electrically-controllable lens(es) described herein can be used to mimic a light field display, which allows for providing the user wearing the HMD with a sense of depth in the displayed imagery. For example, a series of control signals can be provided to the electrically-controllable lens(es) in synchronization with a refresh rate of the display panel(s) of the HMD, as described in more detail below. By varying the control signals provided to the electrically-controllable lens(es) in synchronization with an update(s) of the HMD's display panel(s), the viewing user can perceive depth in the displayed imagery, thereby providing the user wearing the HMD with a more immersive viewing experience.

Also disclosed herein are systems including a HMD configured to implement the techniques and processes disclosed herein, as well as non-transitory computer-readable media storing computer-executable instructions to implement the techniques and processes disclosed herein. Although the techniques and systems disclosed herein are often discussed, by way of example, in the context of video game applications, and specifically VR gaming applications, it is to be appreciated that the techniques and systems described herein may provide benefits with other applications, including, without limitation, non-VR applications (e.g., AR applications, MR applications, etc.), and/or non-gaming applications, such as industrial machine applications, defense applications, robotics applications, and the like.

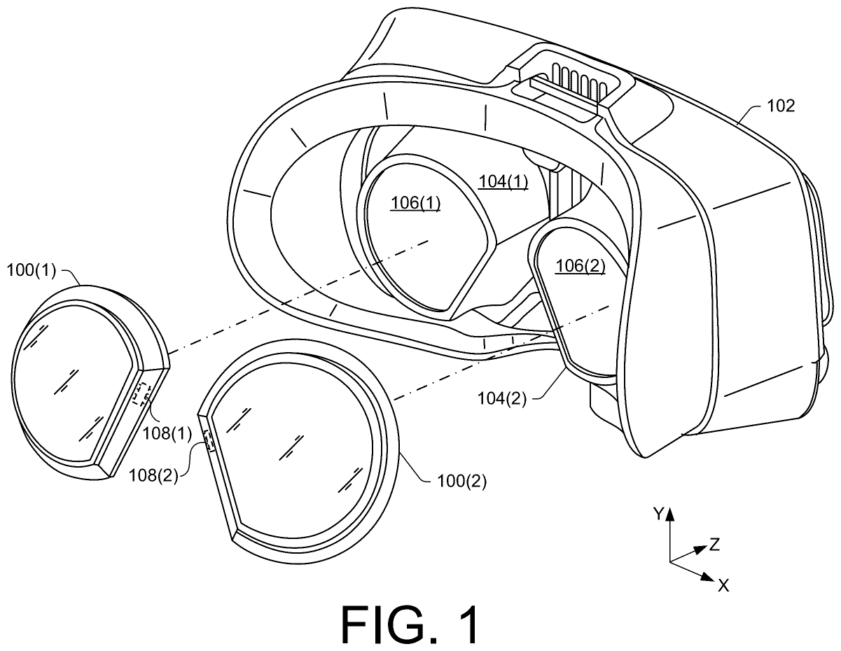

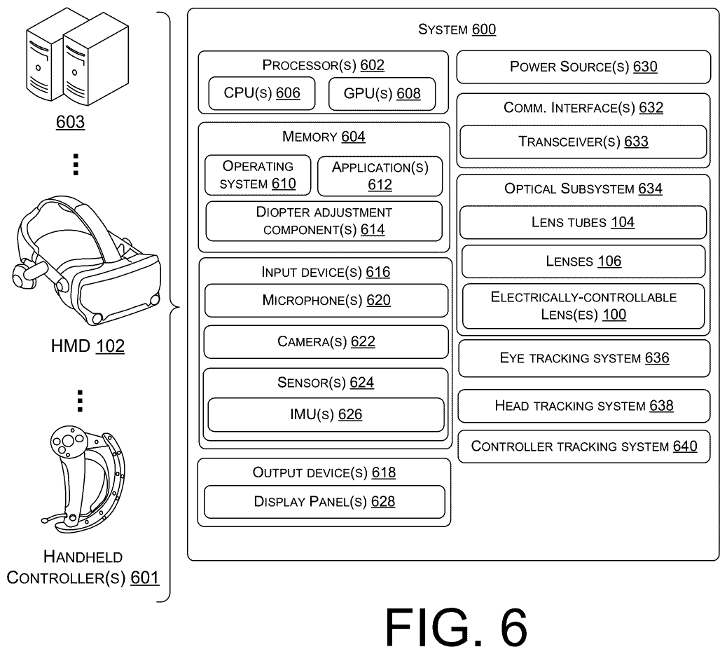

FIG. 1 illustrates a perspective view of an example pair of electrically-controllable lenses 100(1), 100(2) (collectively 100) and an example HMD 102 having a pair of lens tubes 104(1), 104(2) (collectively 104) to which the electrically-controllable lenses 100 may be coupled, in accordance with embodiments disclosed herein. In some examples, the HMD 102 is a standalone HMD 102 (sometimes referred to as an “all-in-one” HMD 102) that includes most, if not all, of the components described herein, and that is operable without assistance, or with minimal assistance, from a separate computer(s). In these examples, the standalone HMD 102 may nevertheless be communicatively coupled with one or more handheld controllers. In some examples, the HMD 102 is a component of a distributed system, which may include the HMD 102, one or more handheld controllers, and at least one additional computer that is separate from, yet communicatively coupled to, the HMD 102 and the one or more handheld controllers. Various implementations of a system including the HMD 102 are described in more detail below with reference to FIG. 6.

A system including the HMD 102 may include one or more processors for executing an application (e.g., a video game) to render associated video content (e.g., a series of images) on a display panel(s) of the HMD 102. In some examples, the HMD 102 may represent a VR headset for use in VR systems, such as for use with a VR gaming system. However, the HMD 102 may additionally, or alternatively, be implemented as an AR headset for use in AR applications, a MR headset for use in MR applications, or a headset that is usable for VR, AR, and/or MR applications that are not game-related (e.g., industrial applications, robot applications, military/weapon applications, medical applications, or the like). In AR, a user of the HMD 102 sees virtual objects overlaid on a real-world environment, whereas, in MR, the user of the HMD 102 sees an interactive view of combined real-world and computer-generated elements, and in VR, the user of the HMD 102 does not typically see a real-world environment, but is fully immersed in a virtual environment, as perceived via the display panel(s) and the optics (e.g., lenses) of the HMD 102. It is to be appreciated that, in some VR systems, pass-through imagery of the real-world environment of the user may be displayed in conjunction with virtual imagery to create an augmented VR environment in a VR system, whereby the VR environment is augmented with real-world imagery (e.g., overlaid on a virtual world), and/or the user of the HMD 102 may be able to toggle between viewing a virtual environment and their real-world environment. Examples described herein pertain primarily to a VR-based HMD 102, but it is to be appreciated that the HMD 102 is not limited to implementation in VR applications.

In FIG. 1, the display panel(s) of the HMD 102 are not visible because they are internal to the housing of the HMD 102. It is to be appreciated that the HMD 102 may include a single display panel or multiple display panels, such as a left display panel and a right display panel of a stereo pair of display panels. The one or more display panels of the HMD 102 may be used to present a series of image frames (sometimes referred to herein as “images” or “frames”) that are viewable by a user wearing the HMD 102. It is to be appreciated that the HMD 102 may include any number of display panels (e.g., more than two display panels, a pair of display panels, or a single display panel). Hence, the terminology “display panel,” as used in the singular herein, may refer to either display panel of a pair of display panels of a two-panel HMD 102, or it may refer to a single display panel of a HMD 102 with any number of display panels (e.g., a single-panel HMD 102 or a multi-panel HMD 102).

The HMD 102 may further include an optical subsystem that directs light emitted by the display panel(s) toward a user's eye(s) using one or more optical elements. The optical subsystem may include various types and combinations of different optical elements. The example of FIG. 1 depicts a pair of lenses 106(1), 106(2) (collectively 106) disposed within the pair of lens tubes 104. In some examples, the lenses 106 are fixed in place within the lens tubes 104 and may include any suitable type of lens, such as Fresnel lenses, convex lenses, concave lenses, or the like. The lens tubes 104 are positioned in front of the display panel(s) of the HMD 102. In a two-panel HMD 102, a stereo frame buffer may render pixels on both display panels of the HMD 102, and the resulting imagery is viewable in stereo through the pair of lenses 106. In a single-panel HMD 102, the HMD 102 may include a single display panel, and each lens 106 is used for one of the user's eyes to view a corresponding image displayed on at least a portion of the display panel. Furthermore, when a user dons the HMD 102, the lens tubes 104 (and the lenses 106 disposed therein) are positioned between the user's eyes and the display panel(s). Although the optical elements (e.g., the lenses 106) of the HMD 102 may be designed to correct one or more optical errors (e.g., barrel distortion, pincushion distortion, longitudinal chromatic aberration, transverse chromatic aberration, spherical aberration, comatic aberration, field curvature, etc.), the lenses 106 may nevertheless be designed for users who are not vision-impaired (i.e., users with “good” vision).

Accordingly, a system including the HMD 102 may include one or more electrically-controllable lenses 100 that are configured to direct light emitted by the display panel(s) of the HMD 102 toward the eye(s) of the user wearing the HMD 102. FIG. 1 illustrates a pair of electrically-controllable lenses 100(1), 100(2), but it is to be appreciated that the system may include a single electrically-controllable lens 100, in some examples. The electrically-controllable lenses 100 depicted in FIG. 1 are usable with the HMD 102 for, among other things, diopter adjustment. That is, a processor(s) of the system can provide a control signal(s) to the electrically-controllable lenses 100 to adjust an optical power of the electrically-controllable lenses 100. For example, the optical power of the electrically-controllable lenses 100 can be increased in order to decrease the focal length of the electrically-controllable lenses 100, or the optical power of the electrically-controllable lenses 100 can be decreased in order to increase the focal length of the electrically-controllable lenses 100. In some examples, using the electrically-controllable lenses 100 for diopter adjustment allows for mimicking a user's prescription eyewear. This, in turn, allows users with impaired vision to have a clear and sharp view of the images displayed on the display panel(s) of the HMD 102 without having to wear their prescription eyewear (e.g., eyeglasses, contact lenses, etc.) underneath the HMD 102.

In some examples, the electrically-controllable lenses 100 are accessories to the HMD 102. In these examples, the electrically-controllable lenses 100 may be referred to as “electrically-controllable lens accessories” or “electrically-controllable lens adapters.” In some examples, a user may visit a website of a vendor of the HMD 102 in order to purchase the HMD 102 online. During this purchase experience (e.g., at checkout), the user may be presented with an option to buy the electrically-controllable lenses 100 as accessories to the HMD 102. A user with impaired vision (e.g., nearsightedness, farsightedness, astigmatism, etc.) may choose to purchase the electrically-controllable lenses 100 to avoid having to wear their prescription eyewear underneath the HMD 102 in order to have a clear and sharp view of the imagery displayed via the HMD 102. In this example, the user may receive a delivery of a package including, among other things, the HMD 102 and the electrically-controllable lenses 100. As accessories to the HMD 102, the electrically-controllable lenses 100 may be configured to be coupled to the pair of lens tubes 104 by the user of the HMD 102. The electrically-controllable lenses 100 may be coupled to the lens tubes 104 in various ways. In general, the electrically-controllable lenses 100 may be sized and shaped to fit on, around, and/or over the lens tubes 104. For example, the electrically-controllable lens 100 may include a substantially flat, transparent substrate having a generally circular-shape that is similar to the shape of the lenses 106 and/or the lens tubes 104. The electrically-controllable lens 100 may further include a rim of material (e.g., rubber, plastic, silicone, etc.) surrounding the transparent substrate at a periphery of the transparent substrate. This rim of material may have a lip that is configured to fit around the front face of the lens tubes 104. In some examples, the electrically-controllable lenses 100 may be secured to the lens tubes 104 by virtue of a press fit or a snap fit between the electrically-controllable lenses 100 and the lens tubes 104. In this manner, the electrically-controllable lenses 100 are prevented from falling off of the lens tubes 104 after being coupled thereto (e.g., the user may have to exert a threshold amount of pull force on the electrically-controllable lenses 100 in order to remove the electrically-controllable lenses 100 from the lens tubes 104). In some examples, magnetic elements may be used to couple the electrically-controllable lenses 100 to the lens tubes 104. For example, each electrically-controllable lens 100 may have a magnet embedded within the outer rim of material that surrounds the transparent substrate of the lens 100, and a corresponding magnet of opposite polarity may be disposed in or on the corresponding lens tube 104 near the front face of the lens tube 104 where the electrically-controllable lens 100 engages the lens tube 104. In this example, the attractive force between the pair of magnets prevents the electrically-controllable lenses 100 from falling off of the lens tubes 104. As another example, an adhesive can be used to couple the electrically-controllable lenses 100 to the lens tubes 104, such as a multi-use (reusable) tape disposed on the surfaces of the electrically-controllable lenses 100 and on the surfaces of the lens tubes 104 that engage the surfaces of the electrically-controllable lenses 100. In some examples, one or more fasteners (e.g., hooks, loops, latches, pins, tabs, screws, etc.) can be used to couple the electrically-controllable lenses 100 to the lens tubes 104. These are merely exemplary ways of coupling the electrically-controllable lenses 100 to the lens tubes 104, and other coupling techniques may be utilized.

As accessories to the HMD 102, the electrically-controllable lenses 100 may be removably coupled to the lens tubes 104, but the term “couple,” as used herein, is not so limited. That is, in some examples, the electrically-controllable lenses 100 may be permanently coupled to the lens tubes 104. This may be the case when the electrically-controllable lenses 100 are built into the HMD 102 at a time of manufacturing the HMD 102. In this example, the electrically-controllable lenses 100 may be considered to be part of the optical subsystem of the HMD 102. That being said, as accessories, the electrically-controllable lenses 100 may become part of the optical subsystem of the HMD 102 once the electrically-controllable lenses 100 are coupled to the lens tubes 104. Regardless, when a user dons the HMD 102, the electrically-controllable lenses 100 are configured to be disposed between the lenses 106 (which are disposed within the lens tubes 104) and the user's eyes. In general, the term “couple,” as used herein, may refer to an indirect coupling or a direct coupling between elements. The term “couple,” as used herein, may also refer to a removable coupling or a permanent coupling between the elements, as mentioned above. Elements are removably coupled if a user or another entity is able to decouple the elements. Elements are permanently coupled if a user or another entity is unable to decouple the elements without destroying or significantly damaging the elements, or without undue effort to disassemble the elements using tools or machinery. As used herein, the term “couple” can be interpreted as connect, attach, affix, join, engage, interface, link, fasten, or bind. Unless otherwise specified herein, the term “couple” is to be interpreted as coupling elements in a mechanical sense, rather than in an electrical or communicative sense. Nevertheless, it is to be appreciated that a mechanical coupling of elements may result in an electrical and/or communicative coupling(s) between multiple elements of a system.

Because the lenses 100 are electrically-controllable for diopter adjustment, the lenses 100 are configured to receive a control signal(s) from a processor(s) in order to adjust the optical power of the electrically-controllable lenses 100. Accordingly, each electrically-controllable lens 100 may include a component(s) that electrically and/or communicatively couples the electrically-controllable lens 100 to the processor(s) that is to provide the control signal(s) for diopter adjustment. In the example of FIG. 1, the electrically-controllable lenses 100 include wireless receivers 108(1), 108(2) (collectively 108) that are configured to receive control signal(s) (and/or other data) using any suitable wireless protocol (e.g., Bluetooth, Near Field Communication (NFC), etc.). In some examples, a user of the HMD 102 may perform one or more steps to wirelessly pair the electrically-controllable lenses 100 with the processor(s) that is to provide the control signal(s) for diopter adjustment (or with the device that includes the processor(s)). In some examples, a transceiver (e.g., a transceiver of the HMD 102, or a transceiver of another device) may be used to wirelessly transmit control signal(s) (and/or other data) from the processor(s) to the electrically-controllable lenses 100. In some examples, the electrically-controllable lenses 100 may include physical connectors, ports, pins, wires, or the like to facilitate a wired connection to the HMD 102 (e.g., using ribbon cable, flexible printed circuits (FPCs), etc.) in order to receive the control signal(s) (and/or other data) via the HMD 102. For example, the electrically-controllable lenses 100 may include Universal Serial Bus (USB) connectors (or ports) that are configured to engage with corresponding USB connectors (or ports) on the lens tubes 104 when the user couples the electrically-controllable lenses 100 to the lens tubes 104. USB is merely an example and other wired protocols may be used. In these examples, the electrically-controllable lenses 100 may receive control signal(s) (and/or other data) using any suitable wired protocol. In some examples, the electrically-controllable lenses 100 may receive power from a power source (e.g., one or more batteries) of the HMD 102, in which case the power can be received via the wireless receivers 108 and/or via physical connectors, ports, pins, wires, etc. of the electrically-controllable lenses 100. In some examples, the electrically-controllable lenses 100 include an onboard power source, such as one or more batteries, which may be rechargeable whenever the electrically-controllable lenses 100 are coupled to the HMD 102 and when the electrically-controllable lenses 100 are receiving power from a power source(s) of the HMD 102. Additionally, or alternatively, the one or more batteries of the electrically-controllable lenses 100 may be recharged whenever the electrically-controllable lenses 100 are plugged into a power outlet (e.g., via a power cable) and/or set upon, or near, a wireless (e.g., inductive) charger/charging station.

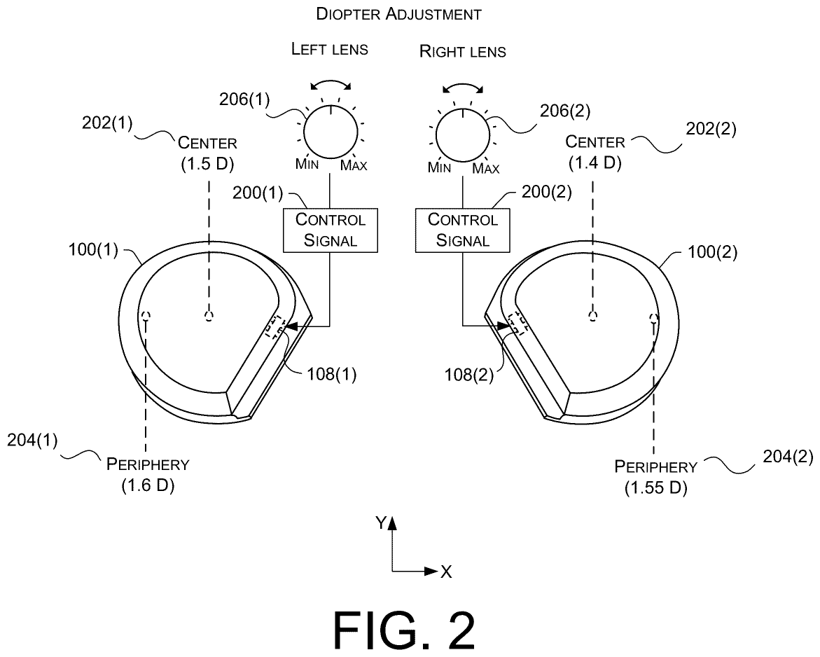

FIG. 2 illustrates a front view of an example pair of electrically-controllable lenses 100, the optical power of which is adjustable via the provisioning of control signals 200(1), 200(2) (collectively 200) to the electrically-controllable lenses 100, in accordance with embodiments disclosed herein. In some examples, the electrically-controllable lenses 100 include liquid crystal (LC) material (e.g., LC molecules). For example, each electrically-controllable lens 100 may include two substantially flat, transparent (e.g., glass) substrates surrounded by a rim of material, with LC material disposed between the transparent substrates and contained (e.g., sealed) therein (e.g., sealed within the transparent substrates by the rim of material). Electrodes (e.g., indium tin oxide (ITO)) can be plated on the transparent substrates such that the electrodes are in contact with the LC material between the transparent substrates, and the LC material can also be compartmentalized into individual cells (or pixels) to provide controllability at any suitable resolution (e.g., at the LC cell, or pixel, level). When the control signals 200 are provided to the electrically-controllable lenses 100, corresponding drive signals may be applied (e.g., via a driver integrated circuit (IC)) to the LC cell electrodes, causing an electric field to be applied across the LC cell(s), thereby changing the orientation of the LC material (e.g., LC molecules) in the LC cell(s). Controlling the orientation of the LC material (e.g., LC molecules) of the electrically-controllable lenses 100 allows for controlling the phase (e.g., optical phase) of light passing through the electrically-controllable lenses 100 to “shape” the beams of light as the light exits the electrically-controllable lenses 100. Said another way, the refractive index can be controlled by controlling the orientation of the LC material (e.g., LC molecules). Because each electrically-controllable lens 100 may include multiple cells of LC material, the electrically-controllable lenses 100 may function similarly to a gradient-index (GRIN) lens, except that the refractive indices can be dynamically controlled, or tuned, in the X-Y plane (radially) via control signals 200, whereas a conventional GRIN lens is not controllable to change the refractive indices on-the-fly. Said another way, the control signals 200 can create any desired refractive index profile in a direction(s) perpendicular to the optical axis; the optical axis corresponding to the Z axis in FIG. 1.

Accordingly, a control signal 200 can cause an electrically-controllable lens 100 to have a first optical power at a center 202 of the electrically-controllable lens 100, and a second optical power at a periphery 204 of the electrically-controllable lens 100, the second optical power different than the first optical power. In the example of FIG. 2, the first electrically-controllable lens 100(1) is tuned to have a first optical power of 1.5 Diopters (D) at the center 202(1) of the electrically-controllable lens 100(1), and a second optical power of 1.6 D at the periphery 204(1) of the electrically-controllable lens 100(1). As mentioned, the second electrically-controllable lens 100(2) can be configured to be controlled independently of the first electrically-controllable lens 100(1). For instance, as shown in FIG. 2, the second electrically-controllable lens 100(2) can be tuned to have a first optical power of 1.4 D at the center 202(2) of the electrically-controllable lens 100(2), and a second optical power of 1.55 D at the periphery 204(2) of the electrically-controllable lens 100(2). These are merely exemplary diopter values and it is to be appreciated that the electrically-controllable lenses 100 can be tuned to have any suitable diopter values. By tuning the electrically-controllable lenses 100 to have gradient refractive indices in the X-Y plane, the control signals 200 can thereby cause the electrically-controllable lenses 100 to modify the phase of the light that passes through their respective centers 202(1), 202(2) by a first amount, and to modify the phase of the light that passes through their respective peripheries 204(1), 204(2) by a second amount different than the first amount. In some examples, the optical power can vary from the center 202 of the lens 100 to the periphery 204 of the lens 100 in accordance with a quadratic function (e.g., a quadratic refractive index change from the center 202 to the periphery 204). It is to be appreciated that the control signal 200 can cause corresponding drive signals to be applied to the LC cell electrodes via any suitable electrical parameter, such as voltage or current, which, in turn, causes an electric field to be applied across the LC cell(s), thereby changing the orientation of the LC material (e.g., LC molecules) and tuning the optical power of the electrically-controllable lens 100 as a function of the radial (X-Y) position on the lens 100.

As mentioned above, a user wearing the HMD 102 can provide user input to adjust the optical power of the electrically-controllable lenses 100, in some examples. The example of FIG. 2 illustrates how user-controlled diopter adjustment can be implemented using an actuator(s) in the form of a rotatable knob 206 (or dial). FIG. 2 also illustrates how each electrically-controllable lens 100 may be controllable independently of the other electrically-controllable lens 100. For example, the user wearing the HMD 102 can rotate the first knob 206(1) in a clockwise or counterclockwise direction to increase or decrease the optical power of the first electrically-controllable lens 100(1) independently of the second electrically-controllable lens 100(2), and/or the user can rotate the second knob 206(2) in a clockwise or counterclockwise direction to increase or decrease the optical power of the second electrically-controllable lens 100(2) independently of the first electrically-controllable lens 100(1). In this manner, the first electrically-controllable lens 100(1) can be tuned to have a first optical power and the second electrically-controllable lens 100(2) can be tuned to have a second optical power that is different than the first optical power.

In some examples, the rotatable knobs 206(1), 206(2) can be disposed on the HMD 102 (e.g., on an outer surface of the housing of the HMD 102) to provide a dedicated control(s) that is/are operable by a finger(s) of the user for adjusting the optical power of the electrically-controllable lenses 100. However, as mentioned above, the type of user input and the types of devices that receive the user input for diopter adjustment can vary depending on the implementation. For instance, the HMD 102 may include an “up” button and a “down” button, a slider, a touch sensor (e.g., a trackpad), or the like, and the user may adjust the optical power of the electrically-controllable lenses 100 using any of these types of controls, or using different types of controls. As another example, the user may provide user input via a handheld controller(s) to adjust the optical power of the electrically-controllable lenses 100, such as by using the handheld controller(s) to interact with a user interface element(s) presented on the display panel(s) of the HMD 102. In this example, an interactive user interface element(s) for diopter adjustment may, at first, look blurry to a user with impaired vision until the user adjusts the optical power to make the view of the displayed imagery clear and sharp. Accordingly, the interactive user interface element(s) for diopter adjustment may be presented in relatively large font (or size) so that the user interface element(s) is/are immediately recognizable to the user notwithstanding a potentially blurry view of the user interface element(s) prior to carrying out the diopter adjustment. In some examples, the user may utter a voice command (e.g., “turn up the optical power of the left lens” or “turn down the optical power of both lenses”) to adjust the optical power of the electrically-controllable lenses 100, and this voice command can be detected by a microphone(s) of the HMD 102 for enabling diopter adjustment. In some examples, the user wearing the HMD 102 can provide user input to adjust the optical power of particular regions of the electrically-controllable lenses 100 in the X-Y plane. For example, the user may be able to provide user input to adjust the optical power at the center 202 of the lens 100, at a periphery 204 of the lens 100, at an intermediate region of the lens 100 between the center 202 and the periphery 204, at a top half of the lens 100, at a bottom half of the lens 100, at a left half of the lens 100, at a right half of the lens 100, and/or any other region of the lens 100 at any suitable level of granularity. Adjustment of the optical power of a sub-region of the electrically-controllable lens 100 can be enabled via interactive user interface element(s) and by providing user input via a handheld controller(s) to interact with the interactive user interface element(s), and/or by depressing a dedicated control (e.g., knob 206) to toggle between regions of the lens 100 and subsequently adjusting the optical power by rotating the knob 206. In some examples, a user interface element(s) may allow the user to enter, search for, and/or select an eye prescription, and the electrically-controllable lenses 100 may be automatically controlled (e.g., via the control signals 200) to set the optical power at an appropriate level(s) for vision correction of the user-provided eye prescription. Regardless of the type of user input or the type of device that receives it, a processor(s) of the system may be configured to provide a control signal(s) 200 to the electrically-controllable lens(es) 100 to adjust the optical power of the electrically-controllable lens(es) 100 based at least in part on the user input. The diopter adjustment is intuitive for a user wearing the HMD 102 because the user can increase or decrease the optical power of the electrically-controllable lenses 100, as needed, until the displayed images look clear and sharp to the user. This diopter adjustment allows for redirecting the light passing through the lens(es) 100 at any desired angle towards the eye(s) of the user wearing the HMD 102.

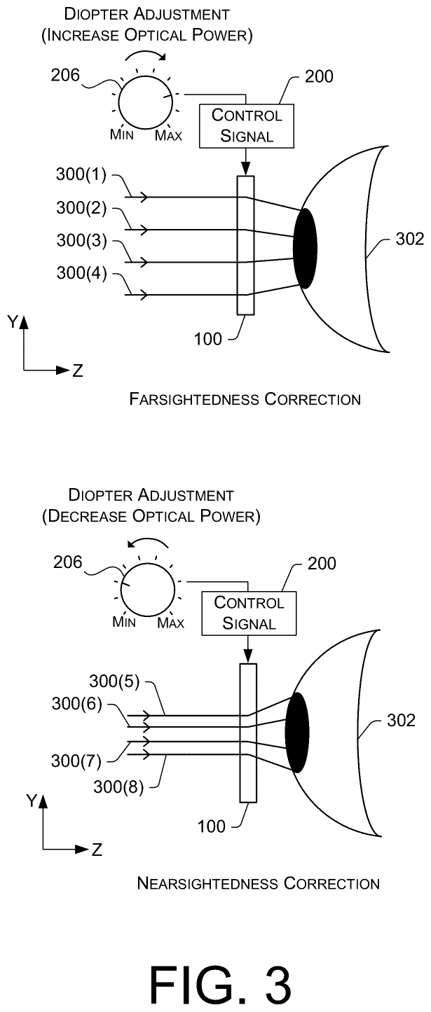

FIG. 3 illustrates side views of an electrically-controllable lens 100, and techniques for using the electrically-controllable lens 100 to increase or decrease the optical power of the electrically-controllable lens 100, in accordance with embodiments disclosed herein. At the top of FIG. 3, a scenario is illustrated where a user wearing the HMD 102 has provided user input to increase the optical power of the electrically-controllable lens 100, such as by rotating a knob 206 associated with the electrically-controllable lens 100 in the clockwise direction. This causes a processor(s) of the system to provide a control signal 200 to the electrically-controllable lens 100, which redirects light 300 exiting the electrically-controllable lens 100. The light 300 in FIG. 3 represents light emitted by the display panel(s) of the HMD 102. As such, the light 300 passes through the electrically-controllable lens 100 before the light 300 reaches the eye 302 of the user wearing the HMD 102 because the electrically-controllable lens 100 is coupled to a lens tube 104 of the HMD 102. In this example scenario, the control signal 200 can control the electrically-controllable lens 100 such that the light 300 converges after exiting the electrically-controllable lens 100, which may be useful in correcting farsightedness (hyperopia). Accordingly, the light 300 can be refocused (e.g., the focus of the light 300 can be adjusted via the control signal 200) to change the angle at which the light 300 exits the electrically-controllable lens 100 as the light 300 approaches the eye 302 of the user wearing the HMD 102. In the example at the top of FIG. 3, four exemplary rays (or beams) of light 300(1), 300(2), 300(3), and 300(4) are shown to illustrate how the refractive indices of the electrically-controllable lens 100 can be tuned in such a way that the refractive indices vary across the lens 100 in the X-Y plane (radially). That is, the light rays 300(2) and 300(3) closer to the center 202 of the lens 100 may exit the lens 100 at a first (acute) angle, while the light rays 300(1) and 300(4) farther from the center 202 of the lens 100 may exit the lens 100 at a second (acute) angle that is less than the first (acute) angle. That is, the light rays 300(1) and 300(4) farther from the center 202 of the lens 100 may converge at a steeper angle than the light rays 300(2) and 300(3) closer to the center 202 of the lens 100. Accordingly, an electrically-controllable lens 100 that is substantially flat can nevertheless be controlled (e.g., via the control signal(s) 200) to function as a curved (convex) lens, in some examples.

At the bottom of FIG. 3, another scenario is illustrated where a user wearing the HMD 102 has provided user input to decrease the optical power of the electrically-controllable lens 100, such as by rotating a knob 206 associated with the electrically-controllable lens 100 in the counterclockwise direction. This causes a processor(s) of the system to provide a control signal 200 to the electrically-controllable lens 100, which redirects the light 300 exiting the electrically-controllable lens 100. In this example scenario, the control signal 200 can control the electrically-controllable lens 100 such that the light 300 diverges after exiting the electrically-controllable lens 100, which may be useful in correcting nearsightedness (myopia). Accordingly, the light 300 can be refocused (e.g., the focus of the light 300 can be adjusted via the control signal 200) to change the angle at which the light 300 exits the electrically-controllable lens 100 as the light 300 approaches the eye 302 of the user wearing the HMD 102. In the example at the bottom of FIG. 3, four exemplary rays (or beams) of light 300(5), 300(6), 300(7), and 300(8) are shown to illustrate how the refractive index of the electrically-controllable lens 100 can vary across the lens 100 in the X-Y plane (radially). That is, the light rays 300(6) and 300(7) closer to the center 202 of the lens 100 may exit the electrically-controllable lens 100 at a first (acute) angle, while the light rays 300(5) and 300(8) farther from the center 202 of the lens 100 may exit the electrically-controllable lens 100 at a second (acute) angle that is less than the first (acute) angle. That is, the light rays 300(5) and 300(8) farther from the center 202 of the lens 100 may diverge at a steeper angle than the light rays 300(6) and 300(7) closer to the center 202 of the lens 100. Accordingly, an electrically-controllable lens 100 that is substantially flat can nevertheless be controlled (e.g., via the control signal(s) 200) to function as a curved (concave) lens, in some examples.

In some examples, at a time of purchasing the HMD 102, a user may provide information about their vision impairment and/or their eye prescription, and the electrically-controllable lenses 100 can be preconfigured (e.g., by the vendor of the HMD 102) with settings that are set to an optical power that is based at least in part on the information provided by the user at the time of purchasing the HMD 102. For example, if a user is purchasing the HMD 102 online, the user may be asked questions such as “are you nearsighted?”, “are you farsighted?”, and/or “do you have astigmatism?”, and the user may provide answers to those questions that allow the vendor of the HMD 102 to preconfigure the electrically-controllable lenses 100 before they are shipped to the user. In some examples, the user can provide their eye prescription to the vendor of the HMD 102, which may allow the vendor to preconfigure the electrically-controllable lenses 100 with even more accurate optical power settings. Preconfiguring the electrically-tunable lenses 100 can allow for providing electrically-controllable lenses 100 that are initially close to the right optical power for the user, and the user can thereafter fine tune the diopter adjustment to improve the clarity and sharpness of the displayed imagery. In this way, the user does not have to experience heavily blurred images if, say, the user has severely impaired vision.

In some examples, a package containing the electrically-controllable lenses 100 may include a booklet of information that can guide the user to adjust the optical power of the electrically-controllable lenses 100 for correcting their particular vision impairment. For example, the booklet may include a table that lists recommended optical power settings for different eye prescriptions. In some examples, the user can download an application to an electronic device (e.g., a mobile phone, a tablet, etc.) that includes similar diopter adjustment information, and/or the downloaded application may walk the user through a series of steps for adjusting the optical power of the electrically-controllable lenses 100 in an appropriate manner for their particular eye prescription.

In some examples, eye tracking components (e.g., light sources, sensors, etc.) of the HMD 102 can be used to automatically determine the eye prescription of the user wearing the HMD 102, and the optical power of the electrically-controllable lenses 100 may be adjusted, without user intervention, based on the determined eye prescription of the user. For example, eye tracking light sources and eye tracking sensors can perform ray tracing techniques where light (e.g., infrared (IR) light) is reflected off of the user's eye(s) to determine (e.g., estimate) their eye prescription, and the determined eye prescription may be provided as input to a function, a model, or the like to determine a control signal(s) 200 for adjusting the electrically-controllable lens(es) 100 in order to provide vision correction for the user wearing the HMD 102.

In some examples, virtual objects may be presented on the display panel(s) of the HMD 102 at different sizes and/or “distances” in a virtual scene to cause the user's eye(s) to focus on particular virtual objects in the virtual scene. In some examples, a processor(s) may provide control signals 102 to the electrically-controllable lenses 100 to toggle the lenses 100 between different optical power settings as part of a computer-led diopter adjustment process. In some examples, the user wearing the HMD 102 may provide feedback during this process to indicate whether and/or which virtual objects look clear and sharp to the user. This may allow the processor(s) to adjust the optical power of the electrically-controllable lenses 100 based on the user feedback.

The processes described herein are illustrated as a collection of blocks in a logical flow graph, which represent a sequence of operations that can be implemented in hardware, software, firmware, or a combination thereof (i.e., logic). In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

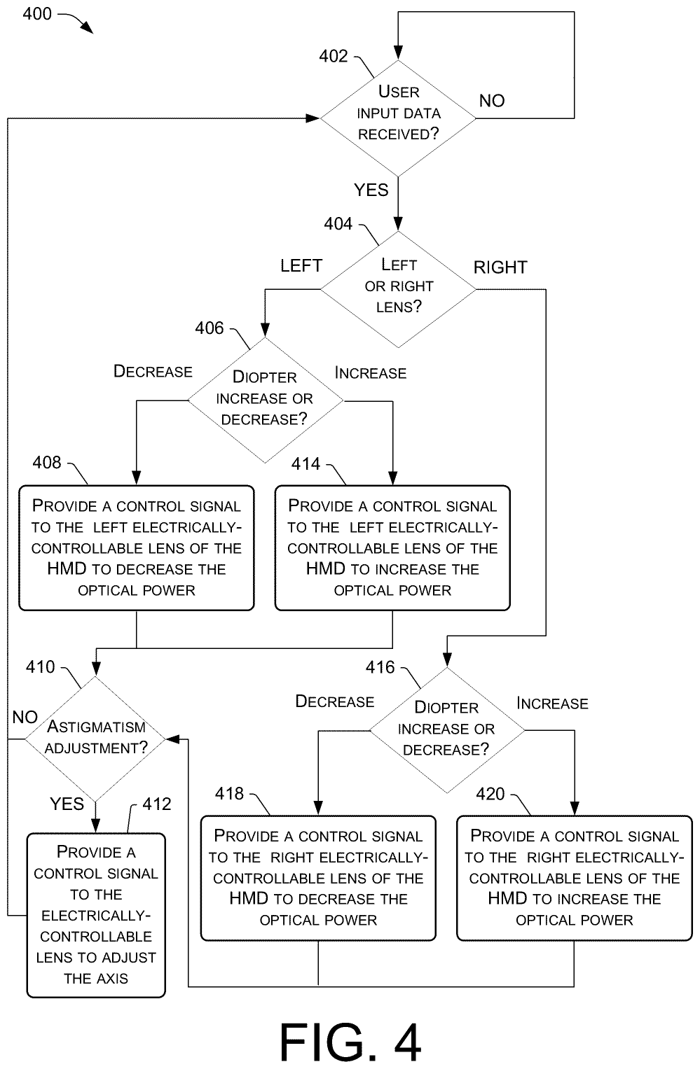

FIG. 4 is a flow diagram of an example process 400 for controlling an electrically-controllable lens(es) 100 of a HMD 102 based on user input provided by a user wearing the HMD 102 in order to provide vision correction for the user, in accordance with embodiments disclosed herein. For discussion purposes, the process 400 is described with reference to the previous figures. Furthermore, the process 400 may be implemented by a system including the HMD 102 and the electrically-controllable lens(es) 100, and the HMD 102 may have a display panel(s), a pair of lens tubes 104, and the electrically-controllable lens(es) 100 may be coupled to the lens tube(s) 104; either removably coupled as an accessory(ies) to the HMD 102, or permanently coupled as part of the optical subsystem of the HMD 102.

At 402, a processor(s) of the system may determine whether it has received user input data indicating that a user wearing the HMD 102 has provided user input to adjust an optical power of the electrically-controllable lens(es) 100 of the HMD 102. As noted above, the type of user input and the types of devices that receive the user input for diopter adjustment can vary depending on the implementation. For instance, the processor(s), at block 402, can monitor for user input data indicating that the user has provided user input via a dedicated control(s) of the HMD 102, such as an actuator (e.g., a rotatable knob 206 (or dial)), an “up” button or a “down” button, a slider, a touch sensor (e.g., a trackpad), or the like. As another example, the processor(s), at block 402, can monitor for user input data indicating that the user has provided user input via a handheld controller(s) to adjust the optical power of the electrically-controllable lenses 100, such as by using the handheld controller(s) (e.g., a joystick, a trackpad, A-, B-, X-, and/or Y-buttons, a trigger, a bumper, a scroll wheel, etc.) to interact with a user interface element(s) presented on the display panel(s) of the HMD 102 for diopter adjustment. In some examples, the processor(s), at block 402, can monitor for user input data indicating that a microphone(s) of the HMD 102 detected a voice command uttered by the user to adjust the optical power of the electrically-controllable lens(es) 100. If such user input data is not received, the process 400 may follow the NO route from block 402 to continue monitoring for the receipt of user input data for diopter adjustment. Once such user input data is received by the processor(s), the process 400 may follow the YES route from block 402 to block 404.

At 404, the processor(s) may determine whether the user input data is associated with a first (e.g., left) electrically-controllable lens 100(1) or a second (e.g., right) electrically-controllable lens 100(2). If dedicated controls are provided (e.g., on the HMD 102) for adjusting the optical power of each electrically-controllable lens 100 independently, the determination at block 404 may include determining which of the dedicated controls was operated by the user. For example, if a first actuator (e.g., a first knob 206(1)) is associated with the first (e.g., left) electrically-controllable lens 100(1), the user input data received at block 402 may indicate that the user provided user input via the first actuator (e.g., the first knob 206(1)), and, therefore, the determination at block 404 is that the first (e.g., left) electrically-controllable lens 100(1) is to be controlled for diopter adjustment. If a second actuator (e.g., a second knob 206(2)) is associated with the second (e.g., right) electrically-controllable lens 100(2), the user input data received at block 402 may indicate that the user provided user input via the second actuator (e.g., the second knob 206(2)), and, therefore, the determination at block 404 is that the second (e.g., right) electrically-controllable lens 100(2) is to be controlled for diopter adjustment. In another example, the user input data received at block 402 may indicate that the user provided user input via a handheld controller(s) to interact with a user interface element(s) presented on the display panel(s) of the HMD 102, and if the user interface element(s) is/are associated with controlling the first (e.g., left) electrically-controllable lens 100(1), the processor(s) determines, at block 404, that the first (e.g., left) electrically-controllable lens 100(1) is to be controlled for diopter adjustment. If, on the other hand, the user interface element(s) is/are associated with controlling the second (e.g., right) electrically-controllable lens 100(2), the processor(s) determines, at block 404, that the second (e.g., right) electrically-controllable lens 100(2) is to be controlled for diopter adjustment. In another example, the user input data received at block 402 may indicate that the user uttered a voice command indicating which electrically-controllable lens 100 they want to control for diopter adjustment. It is to be appreciated that, in some examples, both electrically-controllable lenses 100 can be controlled simultaneously, in which case, the process 400 may follow both the LEFT and RIGHT routes from block 404. However, to illustrate how the electrically-controllable lenses 100 can be controlled independently of one another, the process 400 is described as following either the LEFT or the RIGHT route from block 404. Accordingly, if the determination at block 404 is that the user input data is associated with the first (e.g., left) electrically-controllable lens 100(1), the process 400 may follow the LEFT route from block 404 to block 406.

At 406, the processor(s) may determine whether to increase or decrease the optical power of the first (e.g., left) electrically-controllable lens 100(1). For example, if a first knob 206(1) is associated with the first (e.g., left) electrically-controllable lens 100(1), the user input data received at block 402 may indicate that the user rotated the first knob 206(1) in a first direction (e.g., counterclockwise), and, therefore, the determination at block 406 may be to decrease the optical power of the first (e.g., left) electrically-controllable lens 100(1). If, on the other hand, the user input data received at block 402 indicates that the user rotated the first knob 206(1) in a second direction (e.g., clockwise), the determination at block 406 may be to increase the optical power of the first (e.g., left) electrically-controllable lens 100(1). In another example, the user input data received at block 402 may indicate that the user provided user input via a handheld controller(s) to interact with a user interface element(s) associated with the first (e.g., left) electrically-controllable lens 100(1) in a certain way (e.g., sliding a virtual slider to the left, or sliding the virtual slider to the right), which allows the processor(s) to determine whether to increase or decrease the optical power of the first (e.g., left) electrically-controllable lens 100(1) at block 406. In another example, the user input data received at block 402 may indicate that the user uttered a voice command indicating that the user wants to increase or decrease the optical power of the first (e.g., left) electrically-controllable lens 100(1). If the determination at block 406 is to decrease the optical power of the first (e.g., left) electrically-controllable lens 100(1), the process 400 may follow the DECREASE route from block 406 to block 408.

At 408, the processor(s) may provide a control signal 200(1) to the first (e.g., left) electrically-controllable lens 100(1) to decrease the optical power of the first (e.g., left) electrically-controllable lens 100(1) based at least in part on the user input data received at block 402. In some examples, the optical power can be adjusted in increments, such that, in response to receiving the user input data, the optical power is decremented by a predefined amount (e.g., by 0.01 D, by 0.1 D, by 0.5 D, by 1 D, etc.) at block 408. In some examples, the user input data indicates an amount by which the optical power is to be adjusted. For example, the amount of rotation of a knob 206 may correspond to a particular amount of adjustment to the optical power of the electrically-controllable lens 100, where a larger amount of rotation of the knob 206 corresponds to a larger amount of optical power adjustment, and a lesser amount of rotation of the knob 206 corresponds to a lesser amount of optical power adjustment. These concepts can be applied to other types of user input, such as an amount by which the user moves a virtual slider on a graphical user interface, an extent of a swipe gesture provided via a touch sensor, etc. In some examples, the control signal 200(1) provided to the first (e.g., left) electrically-controllable lens 100(1) at block 408 causes a corresponding drive signal(s) to be applied (e.g., via a driver IC) to LC cell electrodes of the first (e.g., left) electrically-controllable lens 100(1), causing an electric field to be applied across the cells of LC material in the first (e.g., left) electrically-controllable lens 100(1), thereby changing the orientation of the LC material (e.g., LC molecules). As described above, by controlling the orientation of the LC material (e.g., LC molecules) via the control signal 200(1), the phase of light 300 passing through the first (e.g., left) electrically-controllable lens 100(1) at particular X-Y locations on the lens 100(1) can be modified. Said another way, the refractive indices of the lens 100(1) can be controlled by controlling the orientation of the LC material (e.g., LC molecules) of the lens 100(1) via the control signal 200(1). In some examples, the control signal 200(1) provided at block 408 can create a refractive index profile in a direction(s) perpendicular to the optical axis (e.g., the Z axis in FIG. 1). For example, the control signal 200(1) provided at block 408 may cause the first (e.g., left) electrically-controllable lens 100(1) to have a first optical power at its center 202(1), and a second optical power at its periphery 204(1), the second optical power different than the first optical power. In other words, the control signal 200(1) provided at block 408 can cause the first (e.g., left) electrically-controllable lens 100(1) to modify the phase of the light 300 that passes through its center 202(1) by a first amount, and to modify the phase of the light 300 that passes through its periphery 204(1) by a second amount different than the first amount. In some examples, the control signal 200(1) provided at block 408 can create a refractive index profile that models a quadratic function (e.g., a quadratic index change from the center 202(1) to the periphery 204(1)). In some examples, the control signal 200(1) provided at block 408 can cause corresponding drive signals to be applied to the LC cell electrodes of the first (e.g., left) electrically-controllable lens 100(1) via any suitable electrical parameter, such as voltage or current, which, in turn, causes an electric field to be applied across the LC cell(s), thereby changing the orientation of the LC material (e.g., LC molecules) and tuning the optical power of the first (e.g., left) electrically-controllable lens 100(1) as a function of the radial (X-Y) position on the lens 100(1).

At 410, following the provisioning of the control signal 200(1) at block 408, the processor(s) may determine whether to adjust for astigmatism. For example, the user input data received at block 402, or additional user input data received after the receipt of the user input data at block 402, may indicate that the user has provided user input to adjust an axis (e.g., by selecting a number within a range of 0 to 180) for correcting astigmatism. If, at block 410, the processor(s) determines to refrain from adjusting for astigmatism (e.g., if the user input data indicates that the user has not provided user input to adjust an axis for correcting astigmatism), the process 400 may follow the NO route from block 410 and may return to block 402 to continue monitoring for the receipt of additional user input data for diopter adjustment. If, at block 410, the processor(s) determines to adjust for astigmatism, the process 400 may follow the YES route from block 410 to block 412.

At 412, the processor(s) may provide a control signal 200(1) to the first (e.g., left) electrically-controllable lens 100(1) to adjust an axis (e.g., to a number within a range of 0 to 180) based at least in part on the user input data, or the additional user input data, received for astigmatism adjustment. In some examples, the control signal 200(1) provided to the first (e.g., left) electrically-controllable lens 100(1) at block 412 causes a corresponding drive signal(s) to be applied (e.g., via a driver IC) to LC cell electrodes of the first (e.g., left) electrically-controllable lens 100(1), causing an electric field to be applied across the cells of LC material in the first (e.g., left) electrically-controllable lens 100(1), thereby changing the orientation of the LC material (e.g., LC molecules) in such a way that the optical power is adjusted in alignment with the axis for astigmatism correction. Following the provisioning of the control signal 200(1) at block 412, the process 400 may return to block 402 to continue monitoring for the receipt of additional user input data for diopter adjustment.

Returning to block 406, if the determination is to increase the optical power of the first (e.g., left) electrically-controllable lens 100(1), the process 400 may follow the INCREASE route from block 406 to block 414, where the processor(s) may provide a control signal 200(1) to the first (e.g., left) electrically-controllable lens 100(1) to increase the optical power of the first (e.g., left) electrically-controllable lens 100(1) based at least in part on the user input data received at block 402. As noted above, the optical power can be adjusted in increments, such that, in response to receiving the user input data, the optical power is incremented by a predefined amount (e.g., by 0.01 D, by 0.1 D, by 0.5 D, by 1 D, etc.) at block 414. In some examples, the optical power of the first (e.g., left) electrically-controllable lens 100(1) is increased by an amount indicated in the user input data (e.g., based on an amount of rotation of a knob 206, an amount by which the user moves a virtual slider on a graphical user interface, an extent of a swipe gesture provided via a touch sensor, etc.). In some examples, the control signal 200(1) provided to the first (e.g., left) electrically-controllable lens 100(1) at block 414 causes a corresponding drive signal(s) to be applied (e.g., via a driver IC) to LC cell electrodes of the first (e.g., left) electrically-controllable lens 100(1), causing an electric field to be applied across the cells of LC material in the first (e.g., left) electrically-controllable lens 100(1), thereby changing the orientation of the LC material (e.g., LC molecules). In some examples, the control signal 200(1) provided at block 414 can create a refractive index profile in a direction(s) perpendicular to the optical axis (e.g., the Z axis in FIG. 1). For example, the control signal 200(1) provided at block 414 may cause the first (e.g., left) electrically-controllable lens 100(1) to have a first optical power at its center 202(1), and a second optical power at its periphery 204(1), the second optical power different than the first optical power. In other words, the control signal 200(1) provided at block 414 can cause the first (e.g., left) electrically-controllable lens 100(1) to modify the phase of the light 300 that passes through its center 202(1) by a first amount, and to modify the phase of the light 300 that passes through its periphery 204(1) by a second amount different than the first amount. In some examples, the control signal 200(1) provided at block 414 can create a refractive index profile that models a quadratic function (e.g., a quadratic index change from the center 202(1) to the periphery 204(1)). In some examples, the control signal 200(1) provided at block 414 can cause corresponding drive signals to be applied to the LC cell electrodes of the first (e.g., left) electrically-controllable lens 100(1) via any suitable electrical parameter, such as voltage or current, which, in turn, causes an electric field to be applied across the LC cell(s), thereby changing the orientation of the LC material (e.g., LC molecules) and tuning the optical power of the first (e.g., left) electrically-controllable lens 100(1) as a function of the radial (X-Y) position on the lens 100(1). Following the provisioning of the control signal 200(1) at block 414, blocks 410 and 412 of the process 400 may be performed, as described above.

Returning to block 404, if the determination is that the user input data received at block 402 is associated with the second (e.g., right) electrically-controllable lens 100(2), the process 400 may follow the RIGHT route from block 404 to block 416, where the processor(s) may determine whether to increase or decrease the optical power of the second (e.g., right) electrically-controllable lens 100(2). For example, if a second knob 206(2) is associated with the second (e.g., right) electrically-controllable lens 100(2), the user input data received at block 402 may indicate that the user rotated the second knob 206(2) in a first direction (e.g., counterclockwise), and, therefore, the determination at block 416 may be to decrease the optical power of the second (e.g., right) electrically-controllable lens 100(2). If, on the other hand, the user input data received at block 402 indicates that the user rotated the second knob 206(2) in a second direction (e.g., clockwise), the determination at block 416 may be to increase the optical power of the second (e.g., right) electrically-controllable lens 100(2). In another example, the user input data received at block 402 may indicate that the user provided user input via a handheld controller(s) to interact with a user interface element(s) associated with the second (e.g., right) electrically-controllable lens 100(2) in a certain way (e.g., sliding a virtual slider to the left, or sliding the virtual slider to the right), which allows the processor(s) to determine whether to increase or decrease the optical power of the second (e.g., right) electrically-controllable lens 100(2) at block 416. In another example, the user input data received at block 402 may indicate that the user uttered a voice command indicating that the user wants to increase or decrease the optical power of the second (e.g., right) electrically-controllable lens 100(2). If the determination at block 416 is to decrease the optical power of the second (e.g., right) electrically-controllable lens 100(2), the process 400 may follow the DECREASE route from block 416 to block 418.

At 418, the processor(s) may provide a control signal 200(2) to the second (e.g., right) electrically-controllable lens 100(2) to decrease the optical power of the second (e.g., right) electrically-controllable lens 100(2) based at least in part on the user input data received at block 402. As noted above, the optical power can be adjusted in increments, such that, in response to receiving the user input data, the optical power is decremented by a predefined amount (e.g., by 0.01 D, by 0.1 D, by 0.5 D, by 1 D, etc.) at block 418. In some examples, the optical power of the second (e.g., right) electrically-controllable lens 100(2) is decreased by an amount indicated in the user input data (e.g., based on an amount of rotation of a knob 206, an amount by which the user moves a virtual slider on a graphical user interface, an extent of a swipe gesture provided via a touch sensor, etc.). In some examples, the control signal 200(2) provided to the second (e.g., right) electrically-controllable lens 100(2) at block 418 causes a corresponding drive signal(s) to be applied (e.g., via a driver IC) to LC cell electrodes of the second (e.g., right) electrically-controllable lens 100(2), causing an electric field to be applied across the cells of LC material in the second (e.g., right) electrically-controllable lens 100(2), thereby changing the orientation of the LC material (e.g., LC molecules). In some examples, the control signal 200(2) provided at block 418 can create a refractive index profile in a direction(s) perpendicular to the optical axis (e.g., the Z axis in FIG. 1). For example, the control signal 200(2) provided at block 418 may cause the second (e.g., right) electrically-controllable lens 100(2) to have a first optical power at its center 202(2), and a second optical power at its periphery 204(2), the second optical power different than the first optical power. In other words, the control signal 200(2) provided at block 418 can cause the second (e.g., right) electrically-controllable lens 100(2) to modify the phase of the light 300 that passes through its center 202(2) by a first amount, and to modify the phase of the light 300 that passes through its periphery 204(2) by a second amount different than the first amount. In some examples, the control signal 200(2) provided at block 418 can create a refractive index profile that models a quadratic function (e.g., a quadratic index change from the center 202(2) to the periphery 204(2)). In some examples, the control signal 200(2) provided at block 418 can cause corresponding drive signals to be applied to the LC cell electrodes of the second (e.g., right) electrically-controllable lens 100(2) via any suitable electrical parameter, such as voltage or current, which, in turn, causes an electric field to be applied across the LC cell(s), thereby changing the orientation of the LC material (e.g., LC molecules) and tuning the optical power of the second (e.g., right) electrically-controllable lens 100(2) as a function of the radial (X-Y) position on the lens 100(2). Following the provisioning of the control signal 200(2) at block 418, blocks 410 and 412 of the process 400 may be performed, as described above, except with respect to the second (e.g., right) electrically-controllable lens 100(2).

Returning to block 416, if the determination is to increase the optical power of the second (e.g., right) electrically-controllable lens 100(2), the process 400 may follow the INCREASE route from block 416 to block 420, where the processor(s) may provide a control signal 200(2) to the second (e.g., right) electrically-controllable lens 100(2) to increase the optical power of the second (e.g., right) electrically-controllable lens 100(2) based at least in part on the user input data received at block 402. As noted above, the optical power can be adjusted in increments, such that, in response to receiving the user input data, the optical power is incremented by a predefined amount (e.g., by 0.01 D, by 0.1 D, by 0.5 D, by 1 D, etc.) at block 420. In some examples, the optical power of the second (e.g., right) electrically-controllable lens 100(2) is increased by an amount indicated in the user input data (e.g., based on an amount of rotation of a knob 206, an amount by which the user moves a virtual slider on a graphical user interface, an extent of a swipe gesture provided via a touch sensor, etc.). In some examples, the control signal 200(2) provided to the second (e.g., right) electrically-controllable lens 100(2) at block 420 causes a corresponding drive signal(s) to be applied (e.g., via a driver IC) to LC cell electrodes of the second (e.g., right) electrically-controllable lens 100(2), causing an electric field to be applied across the cells of LC material in the second (e.g., right) electrically-controllable lens 100(2), thereby changing the orientation of the LC material (e.g., LC molecules). In some examples, the control signal 200(2) provided at block 420 can create a refractive index profile in a direction(s) perpendicular to the optical axis (e.g., the Z axis in FIG. 1). For example, the control signal 200(2) provided at block 420 may cause the second (e.g., right) electrically-controllable lens 100(2) to have a first optical power at its center 202(2), and a second optical power at its periphery 204(2), the second optical power different than the first optical power. In other words, the control signal 200(2) provided at block 420 can cause the second (e.g., right) electrically-controllable lens 100(2) to modify the phase of the light 300 that passes through its center 202(2) by a first amount, and to modify the phase of the light 300 that passes through its periphery 204(2) by a second amount different than the first amount. In some examples, the control signal 200(2) provided at block 420 can create a refractive index profile that models a quadratic function (e.g., a quadratic index change from the center 202(2) to the periphery 204(2)). In some examples, the control signal 200(2) provided at block 420 can cause corresponding drive signals to be applied to the LC cell electrodes of the second (e.g., right) electrically-controllable lens 100(2) via any suitable electrical parameter, such as voltage or current, which, in turn, causes an electric field to be applied across the LC cell(s), thereby changing the orientation of the LC material (e.g., LC molecules) and tuning the optical power of the second (e.g., right) electrically-controllable lens 100(2) as a function of the radial (X-Y) position on the lens 100(2). Following the provisioning of the control signal 200(2) at block 420, blocks 410 and 412 of the process 400 may be performed with respect to the second (e.g., right) electrically-controllable lens 100(2), as described above. As indicated by the return arrow from block 412 to block 402, the process 400 may iterate as the user continues to adjust the optical power of the electrically-controllable lens(es) 100 until the view of the displayed imagery is clear and sharp to the user.

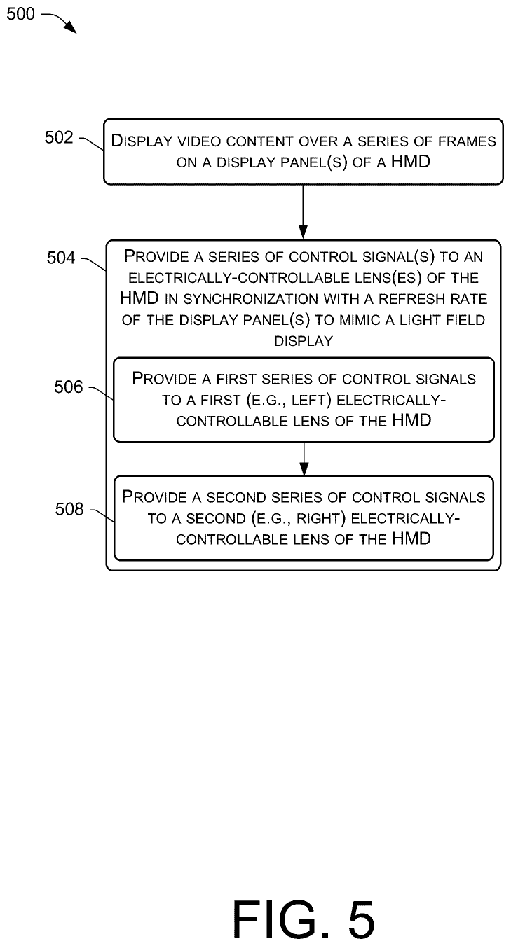

FIG. 5 is a flow diagram of an example process 500 for using an electrically-controllable lens(es) 100 to mimic a light field display in a HMD 102, in accordance with embodiments disclosed herein. For discussion purposes, the process 500 is described with reference to the previous figures. Furthermore, the process 500 may be implemented by a system including the HMD 102 and the electrically-controllable lens(es) 100, and the HMD 102 may have a display panel(s), a pair of lens tubes 104, and the electrically-controllable lens(es) 100 may be coupled to the lens tube(s) 104; either removably coupled as an accessory(ies) to the HMD 102, or permanently coupled as part of the optical subsystem of the HMD 102. It is also to be appreciated that the process 500 can be performed in conjunction with the process 400.

At 502, a processor(s) of the system may cause a display panel(s) of the HMD 102 to display video content (e.g., a series of images) over a series of frames. For example, the processor(s) may execute an application (e.g., a video game) to render associated video content (e.g., a series of images) on a display panel(s) of the HMD 102. Furthermore, the frames may be rendered at a target frame rate and/or the display panel(s) may have a refresh rate (e.g., fixed or variable) at which the images corresponding to the rendered frames are presented on the display panel(s) of the HMD 102.

At 504, the processor(s) may provide a series of control signals 200 to the electrically-controllable lens(es) 100 in synchronization with a refresh rate of the display panel(s) of the HMD 102. The control signals 200 provisioned at block 504 to the electrically-controllable lens(es) 100 may adjust the optical power of the electrically-controllable lens(es) 100. In this manner, a first control signal 200 of the series of control signals 200 provisioned at block 504 may adjust the optical power of the electrically-controllable lens(es) 100 to a first optical power, and then a second control signal 200 of the series of control signals 200 may adjust the optical power of the electrically-controllable lens(es) 100 to a second optical power that may be different than the first optical power, and so on and so forth. Accordingly, the control signals 200 can vary over time and may be provided in synchronization with the refresh rate of the display panel(s) of the HMD 102. For a pair of electrically-controllable lenses 100(1), 100(2), the provisioning of the series of control signals 200 at block 504 may include sub-blocks 506 and 508. At 506, for example, the processor(s) may provide a first series of control signals 200(1) to the first (e.g., left) electrically-controllable lens 100(1) in synchronization with the refresh rate of the display panel(s) of the HMD 102, and/or, at 508, for example, the processor(s) may provide a second series of control signals to the second (e.g., right) electrically-controllable lens 100(2) in synchronization with the refresh rate of the display panel(s) of the HMD 102.

Accordingly, the electrically-controllable lens(es) 100 can be used in accordance with the process 500 to mimic a light field display, which allows for providing the user wearing the HMD 102 with a sense of depth in the displayed imagery. By varying the control signals provided to the electrically-controllable lens(es) 100 in synchronization with an update(s) of the HMD's display panel(s), the viewing user can perceive depth in the displayed imagery, thereby providing a more immersive viewing experience for the user wearing the HMD 102. Said another way, the process 500 is a technique for providing control signals 200 to the electrically-controllable lens(es) 100 such that the control signals 200 are time-sequentially-synced with the images displayed on the display panel(s) of the HMD 102, which provides the electrically-controllable lens(es) 100 with a time-sequential variation of optical power that provides the user's brain with angular information associated with the displayed imagery in addition to intensity information.

FIG. 6 illustrates example components of a system 600 in which the techniques disclosed herein can be implemented, in accordance with embodiments disclosed herein. As mentioned above, the system 600 can include a standalone HMD 102, the electrically-controllable lens(es) 100, and potentially one or more handheld controllers 601. Alternatively, the system 600 can be a distributed system including the HMD 102, the electrically-controllable lens(es) 100, potentially one or more handheld controller(s) 601, and one or more additional computers 603 that is/are communicatively coupled to the HMD 102. In FIG. 6, the additional computer(s) 603 may represent a host computer, and/or a remote system. For example, the system 600 may include a host computer communicatively coupled to the HMD 102 and potentially the handheld controller(s) 601. In some examples, the host computer may be collocated in the same environment as the HMD 102 and the handheld controller(s) 601, such as a household of a user who is wearing the HMD 102 and holding the handheld controller(s) 601. The host computer, the HMD 102, and the handheld controller(s) 601 may be communicatively coupled together wirelessly and/or via a wired connection. For example, the devices 102/601/603 may exchange data using Wi-Fi, Bluetooth, radio frequency (RF), and/or any other suitable wireless protocol. Additionally, or alternatively, the devices 102/601/603 may include one or more physical ports to facilitate a wired connection (e.g., a tether, a cable(s), etc.) for data transfer therebetween. In some examples, the system 600 may include a remote system in addition to, or in lieu of, a host computer that is located in the environment of the HMD 102 and the handheld controller(s) 601. The remote system may be communicatively coupled to the host computer and/or to the HMD 102 via a wide-area network(s), such as the Internet. Accordingly, the remote system may represent one or more server computers that are located at one or more remote geographical locations with respect to the geographical location of the HMD 102 and the handheld controller(s) 601. In other examples, the network(s) may represent a local area network (LAN), and, while the remote system is considered to be remote from the HMD 102, the remote system may be located in the same building as the HMD 102, for example. The HMD 102, the handheld controller(s) 601, and the additional computer(s) 603 (e.g., a host computer and/or remote system) collectively represent a distributed system.

By being communicatively coupled together, the HMD 102, the handheld controller(s) 601, and the additional computer(s) 603 may be configured to work together in a collaborative fashion to output video content and/or audio content via the HMD 102. Accordingly, at least some of the components, programs, and/or data described herein, such as a processor(s) 602, an application(s) 612 that is executable by the processor(s) 602, or the like, can reside on the additional computer(s) 603. Alternatively, as mentioned above, the components, programs, and/or data can reside entirely on the HMD 102, such as in a standalone HMD 102. The additional computer(s) 603 can be implemented as any type of computing device and/or any number of computing devices, including, without limitation, a personal computer (PC), a laptop computer, a desktop computer, a portable digital assistant (PDA), a mobile phone, tablet computer, a set-top box, a game console, a server computer, a wearable computer (e.g., a smart watch, etc.), or any other electronic device that can transmit/receive data.

The HMD 102 may be implemented as a device that is to be worn by a user (e.g., on a head of the user). In some embodiments, the HMD 102 may be head-mountable, such as by allowing a user to secure the HMD 102 on his/her head using a securing mechanism (e.g., an adjustable band) that is sized to fit around a head of a user. In some embodiments, the HMD 102 comprises a VR, AR, or MR headset that includes a near-eye or near-to-eye display(s). As such, the terms “wearable device”, “wearable electronic device”, “VR headset”, “AR headset”, “MR headset,” and “head-mounted display (HMD)” may be used interchangeably herein to refer to the device 102. However, it is to be appreciated that these types of devices are merely example of a HMD 102, and it is to be appreciated that the HMD 102 may be implemented in a variety of other form factors.

In the illustrated implementation, the system 600 includes the one or more processors 602 and the memory 604 (e.g., computer-readable media 604). In some implementations, the processors(s) 602 may include a CPU(s) 606, a GPU(s) 608, both a CPU(s) 606 and a GPU(s) 608, a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 602 may possess its own local memory, which also may store program modules, program data, and/or one or more operating systems.

The memory 604 may include volatile and nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, redundant array of independent disks (RAID) storage systems, or any other medium which can be used to store the desired information and which can be accessed by a computing device. The memory 604 may be implemented as computer-readable storage media (“CRSM”), which may be any available physical media accessible by the processor(s) 602 to execute instructions stored on the memory 604. In one basic implementation, CRSM may include RAM and Flash memory. In other implementations, CRSM may include, but is not limited to, ROM, EEPROM, or any other non-transitory and/or tangible medium which can be used to store the desired information and which can be accessed by the processor(s) 602.

In general, the system 600 may include logic (e.g., software, hardware, and/or firmware, etc.) that is configured to implement the techniques, functionality, and/or operations described herein. The computer-readable media 604 is shown as including various modules, such as instruction, datastores, and so forth, which may be configured to execute on the processor(s) 602 for carrying out the techniques, functionality, and/or operations described herein. A few example functional modules are shown as stored in the computer-readable media 604 and executable on the processor(s) 602, although the same functionality may alternatively be implemented in hardware, firmware, or as a system on a chip (SOC), and/or other logic.

An operating system module 610 may be configured to manage hardware within and coupled to the system 600 for the benefit of other modules. In addition, in some instances the system 600 may include one or more applications 612 stored in the memory 604 or otherwise accessible to the system 600. In some examples, the application(s) 612 includes a gaming application (e.g., a video game, such as a VR video game). However, the system 600 may include any number or type of applications and is not limited to the specific example shown here. A diopter adjustment component(s) 614 may be configured to perform the techniques described herein to adjust the optical power of the electrically-controllable lens(es) 100. For example, the diopter adjustment component(s) 614 may be configured to perform the process 400, and/or the process 500, as described above.

Generally, the system 600 has input devices 616 and output devices 618. The input devices 616 may include the handheld controller(s) 601, in some examples. In some implementations, one or more microphones 620 may function as input devices 616 to receive audio input, such as user voice input. In some implementations, one or more cameras 622 or other types of sensors 624, such as an inertial measurement unit (IMU) 626, or the like, may function as input devices 616. For example, the IMU 626 may be configured to detect head motion of the user wearing the HMD 102, including for gestural input purposes. The sensors 624 may further include sensors used to generate motion, position, and orientation data, such as gyroscopes, accelerometers, magnetometers, color sensors, or other motion, position, and orientation sensors. The sensors 624 may also include sub-portions of sensors, such as a series of active or passive markers that may be viewed externally by a camera or color sensor in order to generate motion, position, and orientation data. For example, a VR headset may include, on its exterior, multiple markers, such as reflectors or lights (e.g., infrared or visible light) that, when viewed by an external camera or illuminated by a light (e.g., infrared or visible light), may provide one or more points of reference for interpretation by software in order to generate motion, position, and orientation data. The sensors 624 may include light sensors that are sensitive to light (e.g., infrared or visible light) that is projected or broadcast by base stations in the environment of the HMD 102. IMU 626 may be an electronic device that generates calibration data based on measurement signals received from accelerometers, gyroscopes, magnetometers, and/or other sensors suitable for detecting motion, correcting error associated with IMU 626, or some combination thereof. Based on the measurement signals such motion-based sensors, such as the IMU 626, may generate calibration data indicating an estimated position of HMD 102 relative to an initial position of HMD 102. For example, multiple accelerometers may measure translational motion (forward/back, up/down, left/right) and multiple gyroscopes may measure rotational motion (e.g., pitch, yaw, and roll). IMU 626 can, for example, rapidly sample the measurement signals and calculate the estimated position of HMD 102 from the sampled data. For example, IMU 626 may integrate measurement signals received from the accelerometers over time to estimate a velocity vector and integrates the velocity vector over time to determine an estimated position of a reference point on HMD 102. The reference point is a point that may be used to describe the position of the HMD 102. While the reference point may generally be defined as a point in space, in various embodiments, reference point is defined as a point within HMD 102 (e.g., a center of the IMU 626). Alternatively, IMU 626 provides the sampled measurement signals to an external console (or other computing device), which determines the calibration data.

The sensors 624 may operate at relatively high frequencies in order to provide sensor data at a high rate. For example, sensor data may be generated at a rate of 1000 hertz (Hz) (or 1 sensor reading every 1 millisecond). In this way, one thousand readings are taken per second. When sensors generate this much data at this rate (or at a greater rate), the data set used for predicting motion is quite large, even over relatively short time periods on the order of the tens of milliseconds. As mentioned, in some embodiments, the sensors 624 may include light sensors that are sensitive to light emitted by base stations in the environment of the HMD 102 for purposes of tracking position and/or orientation, pose, etc., of the HMD 102 in three-dimensional (3D) space. The calculation of position and/or orientation may be based on timing characteristics of light pulses and the presence or absence of light detected by the sensors 624.

In some embodiments, additional input devices 616 may be provided in the form of a keyboard, keypad, mouse, touch screen, joystick, and the like. In some examples, the HMD 102 may omit a keyboard, keypad, or other similar forms of mechanical input. In some examples, the HMD 102 may include control mechanisms, such as basic volume control button(s) for increasing/decreasing volume, as well as power and reset buttons. In some examples, as described above, the HMD 102 a dedicated control(s) used for diopter adjustment via the electrically-controllable lens(es) 100, such as an actuator (e.g., a rotatable knob(s) 206 (or dial(s))), an “up” button(s) or a “down” button(s), a slider(s), a touch sensor(s) (e.g., a trackpad(s)), or the like.

The output devices 618 may include a display(s) or display panels 628, (e.g., a stereo pair of display panels). The display panel(s) 628 of the HMD 102 may utilize any suitable type of display technology, such as an emissive display that utilizes light emitting elements (e.g., light emitting diodes (LEDs)) to emit light during presentation of frames on the display panel(s) 628. As an example, display panel(s) 628 of the HMD 102 may comprise liquid crystal displays (LCDs), organic light emitting diode (OLED) displays, inorganic light emitting diode (ILED) displays, or any other suitable type of display technology for HMD applications. The output devices 618 may further include, without limitation, a light element (e.g., LED), a vibrator to create haptic sensations, as well as one or more speakers (e.g., an off-ear speaker(s)).

The system 600 may include a power source(s) 630, such as one or more batteries. For example, the HMD 102 may be powered by one or more batteries, and/or the handheld controller(s) 601 may be powered by one or more batteries. Additionally, or alternatively, the HMD 102 and/or the handheld controller(s) 601 may include a power cable port to connect to an external power source via wired means, such as a cable.

The system 600 (e.g., the HMD 102, the electrically-controllable lens(es) 100, and/or the handheld controller(s) 601) may further include a communications interface(s) 632, such as a wireless unit coupled to a transceiver(s) 633 and/or an antenna(s) to facilitate a wireless connection to a network. In some examples, the transceiver(s) 633 is configured facilitate wireless transmission of control signals from the processor(s) 602 to the electrically-controllable lens(es) 100. Such a wireless unit may implement one or more of various wireless technologies, such as Wi-Fi, Bluetooth, radio frequency (RF), and so on. It is to be appreciated that the HMD 102, the electrically-controllable lens(es) 100, and/or the handheld controller(s) 601 may further include physical ports to facilitate a wired connection to a network, a connected peripheral device (including the compute(s) 603, such as a host computer, which may be a PC, a game console, etc.), or a plug-in network device that communicates with other wireless networks.

The HMD 102 may further include optical subsystem 634 that directs light from the electronic display panel(s) 628 to a user's eye(s) 302 using one or more optical elements. The optical subsystem 634 may include various types and combinations of different optical elements, including, without limitation, apertures, lenses 106 (e.g., Fresnel lenses, convex lenses, concave lenses, etc.), filters, and so forth. In some embodiments, one or more optical elements in optical subsystem 634 may have one or more coatings, such as anti-reflective coatings. Magnification of the image light 300 by optical subsystem 634 allows electronic display panel(s) 628 to be physically smaller, weigh less, and consume less power than larger displays. Additionally, magnification of the image light 300 may increase a field of view (FOV) of the displayed content (e.g., images). For example, the FOV of the displayed content is such that the displayed content is presented using almost all (e.g., 120-150 degrees diagonal), and in some cases all, of the user's FOV. AR applications may have a narrower FOV (e.g., about 40 degrees FOV). Optical subsystem 634 may be designed to correct one or more optical errors, such as, without limitation, barrel distortion, pincushion distortion, longitudinal chromatic aberration, transverse chromatic aberration, spherical aberration, comatic aberration, field curvature, and so forth. In some embodiments, content provided to electronic display panel(s) 628 for display is pre-distorted, and optical subsystem 634 corrects the distortion when it receives image light from electronic display panel(s) 628 generated based on the content. The optical subsystem 634 may further include the aforementioned lens tubes 104 of the HMD 102, and the electrically-controllable lens(es) 100 described herein.

The HMD system 600 may further include an eye tracking system 636 that generates eye tracking data. The eye tracking system 636 may include, without limitation, an eye tracking sensor(s), such as a camera(s) or other optical sensor(s) inside HMD 102 to capture image data (or information) of a user's eye(s) 302, and the eye tracking system 636 may use the captured data/information to identify the pupil(s) of the eye(s) 302 and/or other landmarks to determine eye orientation, 3D position of the eye(s) 302, interpupillary distance, interocular distance, motion vectors, including a magnitude of torsion and rotation (i.e., roll, pitch, and yaw), and/or gaze directions for each eye 302. In one example, light, such as infrared light, is emitted from a light source(s) within HMD 102 and reflected from each eye 302. The reflected light is received or detected by the eye tracking sensor(s) (e.g., a camera) of the eye tracking system 636 and analyzed to extract eye rotation from changes in the infrared light reflected by each eye. Many methods for tracking the eyes 302 of a user can be used by eye tracking system 636. Accordingly, eye tracking system 636 may track up to six degrees of freedom of each eye 302 (i.e., 3D position, roll, pitch, and yaw) and at least a subset of the tracked quantities may be combined from two eyes 302 of a user wearing the HMD 102 to estimate a gaze point (i.e., a 2D location or position (or 3D location or position in the virtual scene) where the user is looking), which may map to a location(s) on the display panel(s) 628 for predicting where the user will be looking in terms of an individual subset (e.g., a row) or a group of contiguous subsets (e.g., a group of contiguous rows) of the pixels of the display panel(s) 628. For example, eye tracking system 636 may integrate information from past measurements, measurements identifying a position of a user's head, and 3D information describing a scene presented by display panel(s) 628. Thus, information for the position and orientation of the user's eyes is used to determine the gaze point in a virtual scene presented by HMD 102 where the user is looking, and to map that gaze point to a location(s) on the display panel(s) 628 of the HMD 102.

The system 600 may further include a head tracking system 638. The head tracking system 638 may leverage one or more of the sensor 624 to track head motion, including head rotation, of the user wearing the HMD 102. For example, the head tracking system 638 can track up to six degrees of freedom of the HMD 102 (i.e., 3D position, roll, pitch, and yaw). These calculations can be made at every frame of a series of frames so that the application 612 can determine how to render a scene in the next frame in accordance with the head position and orientation. In some embodiments, the head tracking system 638 is configured to generate head tracking data that is usable to predict a future pose (position and/or orientation) of the HMD 102 based on current and/or past data, and/or based on the known/implied scan out latency of the individual subsets of pixels in a display system. This is because the application 612 is asked to render a frame before the user actually sees the light 300 (and, hence, the image) on the display panel(s) 628. Accordingly, a next frame can be rendered based on this future prediction of head position and/or orientation that was made at an earlier point in time. Rotation data provided by the head tracking system 638 can be used to determine both direction of HMD 102 rotation, and amount of HMD 102 rotation in any suitable unit of measurement. For example, rotational direction may be simplified and output in terms of positive or negative horizontal and positive or negative vertical directions, which correspond to left, right, up, and down. Amount of rotation may be in terms of degrees, radians, etc. Angular velocity may be calculated to determine a rate of rotation of the HMD 102.

The system 600 may further include a controller tracking system 640. The controller tracking system 640 may leverage one or more of the sensors 624 to track controller motion. For example, the controller tracking system 640 can track up to six degrees of freedom of the controllers 601 the user holds in his/her hands (i.e., 3D position, roll, pitch, and yaw). These calculations can be made at every frame of a series of frames so that an application 612 (e.g., a video game) can determine how to render virtual controllers and/or virtual hands in a scene in the next frame in accordance with the controller position(s) and orientation(s). In some embodiments, the controller tracking system 640 is configured to predict a future position and/or orientation of the controller(s) 601 based on current and/or past data, as described above with respect to the head tracking system 638.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
a head-mounted display (HMD) comprising:
a display panel; and
a pair of lens tubes;
a pair of electrically-controllable lenses comprising a first electrically-controllable lens and a second electrically-controllable lens, the pair of electrically-controllable lenses configured to:
be coupled to the pair of lens tubes; and
direct light emitted by the display panel toward eyes of a user wearing the HMD;
a processor; and
memory storing computer-executable instructions that, when executed by the processor, cause the processor to provide:
a first control signal to the first electrically-controllable lens to adjust a first optical power of the first electrically-controllable lens; and
a second control signal to the second electrically-controllable lens to adjust a second optical power of the second electrically-controllable lens.

2. The system of claim 1, wherein the first control signal causes the first electrically-controllable lens to:
modify phase of the light that passes through a center of the first electrically-controllable lens by a first amount; and
modify the phase of the light that passes through a periphery of the first electrically-controllable lens by a second amount different than the first amount.

3. The system of claim 1, wherein:
the computer-executable instructions, when executed by the processor, further cause the processor to receive first user input data indicating that the user has provided first user input to adjust the first optical power of the first electrically-controllable lens; and
the first control signal is provided to the first electrically-controllable lens based at least in part on the first user input data.

4. The system of claim 3, wherein:
the computer-executable instructions, when executed by the processor, further cause the processor to receive second user input data indicating that the user has provided second user input to adjust the second optical power of the second electrically-controllable lens; and
the second control signal is provided to the second electrically-controllable lens based at least in part on the second user input data.

5. The system of claim 1, wherein the pair of electrically-controllable lenses are accessories to the HMD and are configured to be coupled to the pair of lens tubes by the user.

6. The system of claim 1, further comprising a transceiver, wherein:
the first control signal is transmitted wirelessly, via the transceiver, to the first electrically-controllable lens; and
the second control signal is transmitted wirelessly, via the transceiver, to the first electrically-controllable lens.

7. The system of claim 1, wherein:
the HMD further comprises a pair of lenses disposed within the pair of lens tubes; and
the pair of electrically-controllable lenses are configured to be disposed between the pair of lenses and the eyes of the user wearing the HMD.

8. The system of claim 1, wherein the computer-executable instructions, when executed by the processor, further cause the processor to:
provide a first series of control signals, including the first control signal, to the first electrically-controllable lens in synchronization with a refresh rate of the display panel; and
provide a second series of control signals, including the second control signal, to the second electrically-controllable lens in synchronization with the refresh rate of the display panel.

9. A method comprising:
receiving, by a processor, user input data indicating that a user wearing a head-mounted display (HMD) has provided user input to adjust an optical power of an electrically-controllable lens of the HMD; and
providing, by the processor, and based at least in part on the user input data, a control signal to the electrically-controllable lens to adjust the optical power of the electrically-controllable lens.

10. The method of claim 9, wherein the control signal causes the electrically-controllable lens to have:
a first optical power at a center of the electrically-controllable lens; and
a second optical power at a periphery of the electrically-controllable lens, the second optical power different than the first optical power.

11. The method of claim 9, wherein the electrically-controllable lens is a first electrically-controllable lens of a pair of electrically-controllable lenses of the HMD, the pair of electrically-controllable lenses including the first electrically-controllable lens and a second electrically-controllable lens, the method further comprising:
receiving, by the processor, second user input data indicating that the user has provided second user input to adjust a second optical power of the second electrically-controllable lens; and
providing, by the processor, and based at least in part on the second user input data, a second control signal to the second electrically-controllable lens to adjust the second optical power of the second electrically-controllable lens.

12. A system comprising:
a head-mounted display (HMD) comprising:
a display panel; and
a pair of lens tubes;
a pair of electrically-controllable lenses coupled, or couplable, to the pair of lens tubes and configured to direct light emitted by the display panel toward eyes of a user wearing the HMD;
a processor; and
memory storing computer-executable instructions that, when executed by the processor, cause the processor to provide a control signal to an electrically-controllable lens of the pair of electrically-controllable lenses to adjust an optical power of the electrically-controllable lens.

13. The system of claim 12, wherein each electrically-controllable lens of the pair of electrically-controllable lenses is independently controllable.

14. The system of claim 12, wherein the control signal causes the electrically-controllable lens to:
modify phase of the light that passes through a center of the electrically-controllable lens by a first amount; and
modify the phase of the light that passes through a periphery of the electrically-controllable lens by a second amount different than the first amount.

15. The system of claim 12, wherein:
the computer-executable instructions, when executed by the processor, further cause the processor to receive user input data indicating that the user has provided user input to adjust the optical power of the electrically-controllable lens; and
the control signal is provided to the electrically-controllable lens based at least in part on the user input data.

16. The system of claim 12, wherein the pair of electrically-controllable lenses are accessories to the HMD and are configured to be coupled to the pair of lens tubes by the user.

17. The system of claim 12, wherein:
the HMD further comprises a pair of lenses within the pair of lens tubes; and
the pair of electrically-controllable lenses are configured to be disposed between the pair of lenses and the eyes of the user wearing the HMD.

18. The system of claim 12, wherein the computer-executable instructions, when executed by the processor, further cause the processor to provide a series of control signals, including the control signal, to the electrically-controllable lens in synchronization with a refresh rate of the display panel.

19. The system of claim 12, wherein:
the electrically-controllable lens is a first electrically-controllable lens of the pair of electrically-controllable lenses; and
the computer-executable instructions, when executed by the processor, further cause the processor to provide a second control signal to a second electrically-controllable lens of the pair of electrically-controllable lenses to adjust a second optical power of the second electrically-controllable lens.

20. The system of claim 19, wherein the second optical power is different than the optical power of the first electrically-controllable lens.
